(19) United States
(12) Patent Application Publication
(10) Pub. No.: US 2006/0176192 A1
(43) Pub. Date: Aug. 10, 2006

(54) Advertising system associated with a traffic signal

(76) Inventor: Claudia Noriega, Handerson, NV (US)

Correspondence Address: PARK LAW FIRM, 3255 WILSHIRE BLVD, SUITE 1110, LOS ANGELES, CA, 90010, US

(21) Appl. No.: 11/053,456

(22) Filed: Feb. 9, 2005

(51) Int. Cl. G08G 1/095

(52) U.S. Cl. 340/907

(57) ABSTRACT

An advertising system associated with a traffic signal includes a display, an information processing device, a data bus for taking a status information from the traffic light system, an information storing device, an interface port, and one or more fastener. The information processing device controls the behavior of the display based on information from the data bus. The information processing device activates the display when the traffic light changes to red, and deactivates a predetermined time period before the traffic light changes to green. The predetermined time period is controlled by the information processing device. The information processing device activates the display with a predetermined visual information stored in the information storing device. The information processing device controls the duration, frequency and order of the visual information. The advertising system includes the color, shape, and size depending on which part of the traffic light pole the advertising system is attached.

### BACKGROUND OF THE INVENTION

The present invention relates to an advertising system associated with a traffic signal. More particularly, this invention relates to an advertising system associated with a traffic signal, which is synchronized with the traffic signal and maximizes the advertising effect without compromising with driver's alertness in driving.

Everyone in the kingdom is ready to do anything to serve the king. The noblemen and knights compete with one another to catch the king's eye at Court.

In the commercial world, the customer is king and the commodity-manufacturers/service-providers are knights. They compete to win the favor of the customer. To win the favor from the customer, they do many things to show off in front of customer, the king; flashing their coat of arms, jousting, employing a court jester and so forth.

Transfer of information is very effective in the form of light. The sense of vision is keenest of the five senses. It reaches far and fast. Its density of information is quite high. That is why tons of ads are created just for the eyes of the potential customers.

Seeing is believing. How to catch the eyes of the customers longer and more frequent is the key of all the advertising business.

Accordingly, a need for an advertising system associated with a traffic signal has been present for a long time. This invention is directed to satisfy the long-felt need, catching the eye of customers.

### SUMMARY OF THE INVENTION

An objective of the invention is to provide an advertising system associated with a traffic signal.

Another objective of the invention is to provide an advertising system associated with a traffic signal, which is synchronized with the traffic signal without undue distraction to drivers and the cross traffic.

An advertising system associated with a traffic signal includes a display, an information processing device, and a data bus for taking a status information from the traffic light system. The information processing device controls the behavior of the display based on the information from the data bus.

The information processing device activates the display when the traffic light changes to red, and deactivates a predetermined time period before the traffic light changes to green. The predetermined time period is controlled by the information processing device.

The advertising system further includes an information storing device. The information processing device activates the display with a predetermined visual information stored in the information storing device. The predetermined information includes advertising visual information on products, weather, temperature, stock market changes, time, shows, concerts, restaurants, Amber Alert, emergency status, National Security Alert, last minute news, etc. The information processing device controls the duration, frequency and order of the predetermined visual information. The predetermined visual information includes an ending part warning the coming red traffic light. The ending part of the warning includes a visual count-down to the change to red of the traffic light.

The advertising system further includes an interface port for connecting a programming device. The programming device programs the behavior and contents of the system. The programming device includes an external information processing device. The external information processing device includes a personal computer. The interface port is connected with the programming device through a electrical cable or an electromagnetic wave transmission.

The advertising system further includes one or more fastener for installing the system on a traffic light support. The fastener is adapted to install the system horizontally or vertically on a horizontal traffic light pole beside the traffic light. Alternatively, the fastener is adapted to install the system horizontally or vertically on a vertical traffic light pole.

The advertising system includes a predetermined color, a predetermined shape, and a predetermined size depending on which part of the traffic light pole the advertising system is attached.

The advertising system minimizes the distraction for the cross traffic not to mention the drivers approaching the front side of the advertising system.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of advertising systems installed on a traffic signal;

FIG. 2 is a detailed view of an advertising system and a traffic light;

FIG. 3 is a block diagram of an advertising system; and

FIG. 4 is a side view of an advertising system installed on a traffic pole.

### DETAILED DESCRIPTION OF THE INVENTION

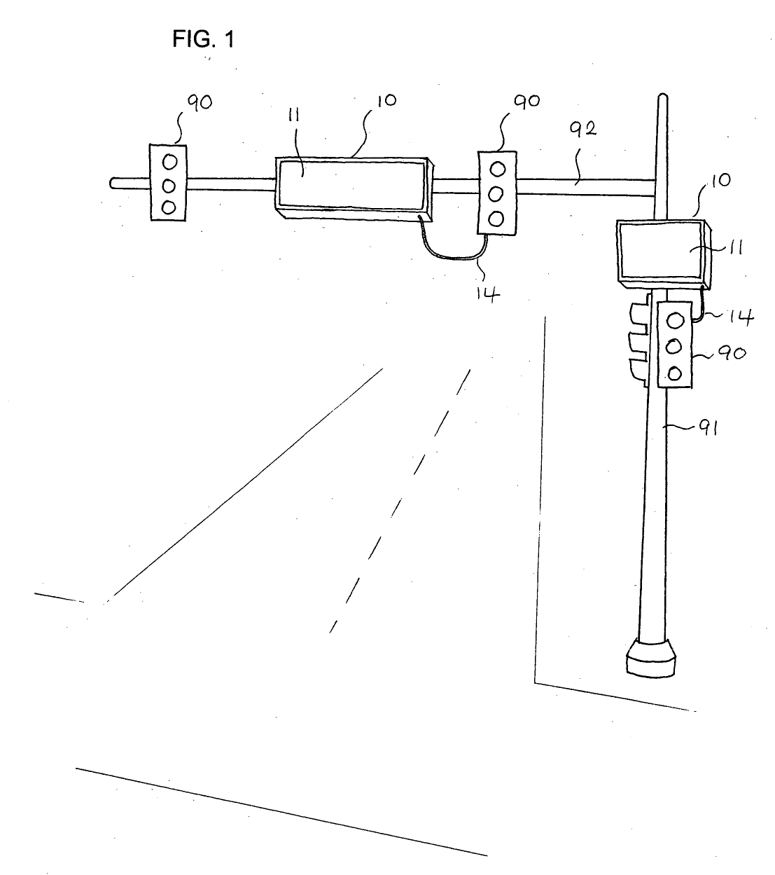

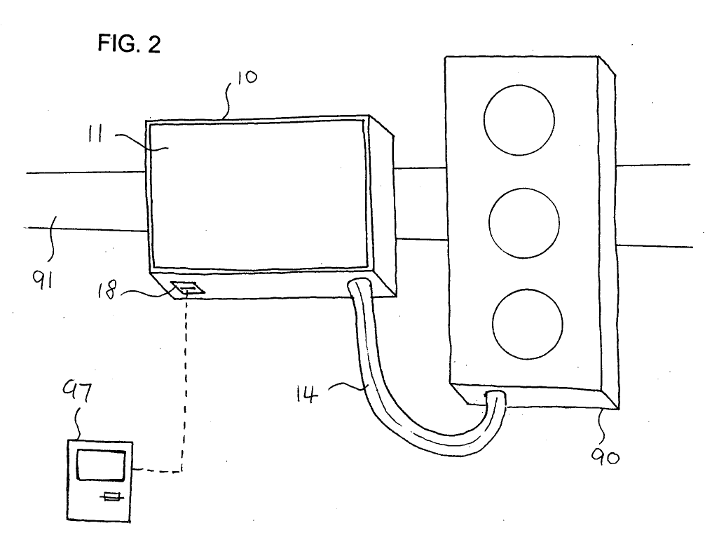

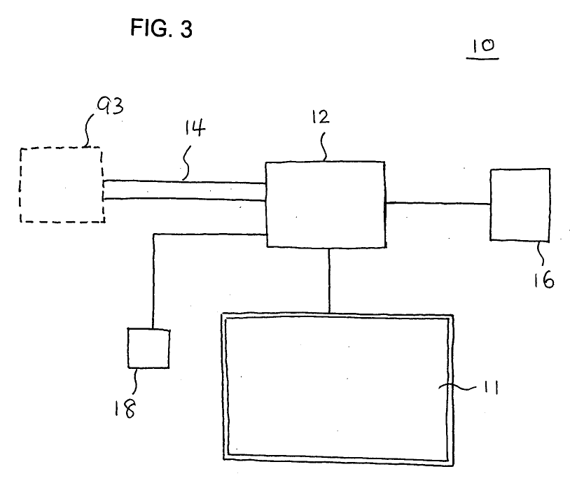

FIG. 1 and FIG. 2 show a perspective view of an advertising system 10 associated with a traffic signal according to the invention. FIG. 3 shows the constituent parts of the advertising system 10.

The advertising system 10 associated with a traffic signal includes a display 11, an information processing device 12, and a data bus 14 for taking a status information from a traffic light system 90. The information processing device 12 controls the behavior of the display 11 based on the information obtained from the traffic system through the data bus 14.

The information processing device 12 activates the display 11 when the traffic light 90 changes to red, and deactivates a predetermined time period before the traffic light 90 changes to green. The predetermined time period is controlled by the information processing device 12. In this way, the advertising system 10 is synchronized with the traffic signal 90.

The advertising system 10 further includes an information storing device 16. The information processing device 12 activates the display 11 with a predetermined visual information stored in the information storing device 16. The predetermined information includes advertising visual information on products, weather, temperature, stock market changes, time, shows, concerts, restaurants, Amber Alert, emergency status, National Security Alert, last minute news. The information processing device 12 controls the duration, frequency and order of the predetermined visual information. The predetermined visual information may include an ending part warning the coming red traffic light. The ending part of the warning may include a visual count-down to the change to red of the traffic light 90. Since all drivers must watch the traffic signal 90 with the red light on, the information displayed on the advertising system 10 becomes another thing they are prone to watch as a matter of course. That way, the effect of advertising is maximized to the extreme without disturbing the traffic light.

The advertising system 10 further includes an interface port 18 for connecting a programming device 97. The programming device 97 programs the behavior and contents of the system 10. The programming device 97 includes an external information processing device. The external information processing device includes a personal computer. The interface port 18 is connected with the programming device 97 through a electrical cable or an electromagnetic wave transmission. Using the programming device 97 connected to the interface port 18, the contents of the advertising system 10 can be easily updated.

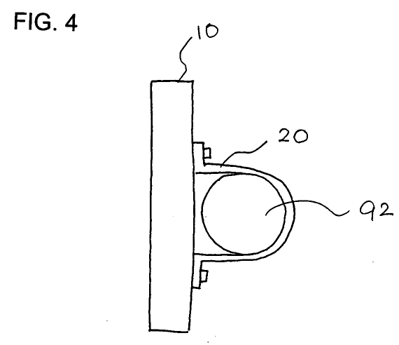

The advertising system 10 further includes one or more fastener 20 for installing the system 10 on a traffic light support 91, 92 as shown in FIG. 4. The fastener 20 is adapted to install the system 10 horizontally or vertically on a horizontal traffic light pole 91, 92 beside the traffic light 90. Alternatively, the fastener 20 is adapted to install the system 10 horizontally or vertically on a vertical traffic light pole 91, 92.

The advertising system 10 includes a predetermined color, a predetermined shape, and a predetermined size depending on which part of the traffic light pole 91, 92 the advertising system 10 is attached.

The advertising system 10 minimizes the distraction for the cross traffic not to mention the drivers approaching the front side of the advertising system 10. The visual information displayed on the advertising system 10 does incur any distraction to the cross traffic and to the drivers approaching the signal while the traffic light is green.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An advertising system associated with a traffic signal comprising:
a) a display;
b) an information processing device; and
c) a data bus for taking a status information from the traffic light system,
wherein the information processing device controls the behavior of the display based on the information from the data bus.

2. The advertising system of claim 1, wherein the information processing device activates the display when the traffic light changes to red, and deactivates a predetermined time period before the traffic light changes to green.

3. The advertising system of claim 2, wherein the predetermined time period is controlled by the information processing device.

4. The advertising system of claim 1 further comprising an information storing device.

5. The advertising system of claim 4, wherein the information processing device activates the display with a predetermined visual information stored in the information storing device.

6. The advertising system of claim 5, wherein the predetermined information comprises advertising visual information on products, weather, temperature, stock market changes, time, shows, concerts, restaurants, Amber Alert, emergency status, National Security Alert, and last minute news.

7. The advertising system of claim 6, wherein the information processing device controls the duration, frequency and order of the predetermined visual information.

8. The advertising system of claim 6, wherein the predetermined visual information comprises an ending part warning the coming red traffic light.

9. The advertising system of claim 8, wherein the ending part of the warning comprises a visual count-down to the change to red of the traffic light.

10. The advertising system of claim 1 further comprising an interface port for connecting a programming device.

11. The advertising system of claim 10, wherein the programming device programs the behavior and contents of the system.

12. The advertising system of claim 11, wherein the programming device comprises an external information processing device.

13. The advertising system of claim 12, wherein the external information processing device comprises a personal computer.

14. The advertising system of claim 10, wherein the interface port is connected with the programming device through a electrical cable or an electromagnetic wave transmission.

15. The advertising system of claim 1 further comprising one or more fastener for installing the system on a traffic light support.

16. The advertising system of claim 15, wherein the fastener is adapted to install the system horizontally or vertically on a horizontal traffic light pole beside the traffic light.

17. The advertising system of claim 15, wherein the fastener is adapted to install the system horizontally or vertically on a vertical traffic light pole.

18. The advertising system of claim 1, wherein the advertising system comprises a predetermined color, a predetermined shape, and a predetermined size depending on which part of the traffic light pole the advertising system is attached.
